(19) United States
(12) Patent Application Publication
(10) Pub. No.: US 2001/0031079 A1
(43) Pub. Date: Oct. 18, 2001

(54) Automatic Inspection Method

(76) Inventor: John Leonard Ryder, Leicester (GB)

Correspondence Address: Young & Basile PC, Suite 624, 3001 West Big Beaver Road, Troy, MI, 48084-3109, US

(21) Appl. No.: 09/802,146

(22) Filed: Mar. 8, 2001

(30) Foreign Application Priority Data
Mar. 11, 2000 (GB) 0005792.7

(51) Int. Cl. G06K 9/00

(52) U.S. Cl. 382/141

(57) ABSTRACT

An automatic inspection method is provided for inspecting the production of breathable fabric produced in a web form and having a regular pattern of discrete areas. The steps include scanning a portion of the web with a camera to produce a digital image of the scanned web and then converting the digital image into a binary format, filtering the binary format image for identifying any deviation from an ideal binary format image and determining if the quality of the pattern is within pre-set limits.

The present invention relates to an automatic inspection method and is particularly, but not exclusively, concerned with such a method for use in the production of fabric, particularly breathable fabric.

In the production of paper, plastic, film, netting and fabric or any other product produced in web form, quality control of the web may be achieved by continuous inspection of the surface of the web for imperfections.

Breathable fabric is manufactured by applying a coating to a base material in discrete areas, such as dots, arranged in a regular array or pattern. The quality of the breathability and waterproofing of the fabric is dependant on the consistent application of the coating to the fabric to provide the regular pattern. Therefore, inspection of the applied coating is necessary to determine whether or not the dots of coating have been applied to the required standard.

Hitherto it has not been possible to identify defects in the dot pattern using standard web processing techniques unless unacceptable constraints were placed on web movement and dot positioning. Hence, the required inspection has been carried out by human operators, who visually inspect the web directly as it is produced.

According to the broadest aspect of the present invention there is provided an automatic inspection method for inspecting a web having a regular pattern of discrete areas thereon or therein, comprising the steps of scanning a portion of the web with a camera to produce a digital image of the scanned web portion, converting the digital image into binary format and counting the number of discrete areas portrayed in the binary format image, filtering the binary format image for identifying any deviation from an ideal binary format image, counting the number of pixels comprising the deviation from the ideal image to yield a grading value, and comparing the discrete area count and grading value of the image with respective pre-set limits for determining the quality of the pattern.

Preferably the step of filtering the binary image format is achieved by applying a convolution mask.

If the grading value and discrete area count are within the pre-set limits, then the quality of the pattern is indicated to be acceptable. However, if the grading value and discrete area count are outside the pre-set limits, then the quality of the pattern is indicated to be unacceptable and the relevant portion of the web is rejected.

Preferably the web being inspected is illuminated from a light source having a constant light output. The light source may be positioned above or below the web being inspected.

Conveniently, the web is travelling continuously in a given direction at a substantially constant speed, corresponding to the speed of production of the web. Alternatively, the web may travel in a stepwise manner being stationary during inspection.

The camera of the method is preferably a digital linescan camera, which may be a monochrome grey-scale camera. An external encoder synchronised to the speed of movement of the web may trigger the camera to scan a line across the web. Preferably, a frame grabber produces a digitised image or frame of the scanned web portion by compiling a number of successive images of lines scanned.

The web being inspected may be of paper, plastic, film, or netting, but is preferably of breathable fabric. The breathable fabric may comprise discrete dots of chemical coating which have been applied to a base fabric in a regular pattern. The shade of the dots may be lighter or darker than the shade of the base fabric, which provides a clearly visible contrast between the dots and base fabric.

The invention will now be described further by way of example with reference to the accompanying drawings in which:

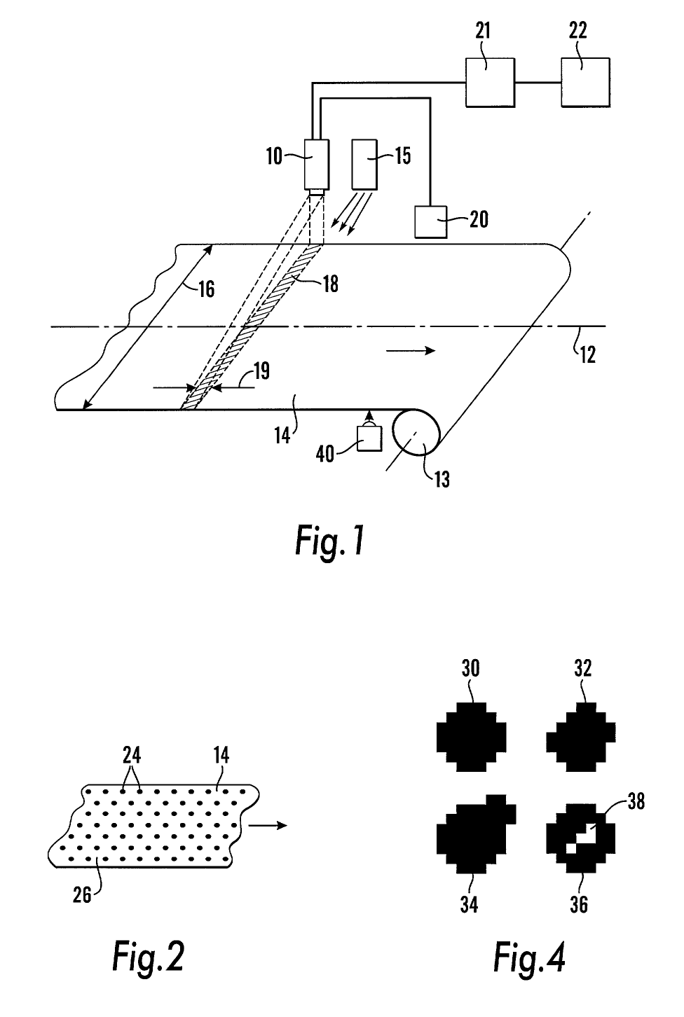

FIG. 1 shows a schematic arrangement of the apparatus of the invention;

FIG. 2 shows a part of a web of breathable fabric;

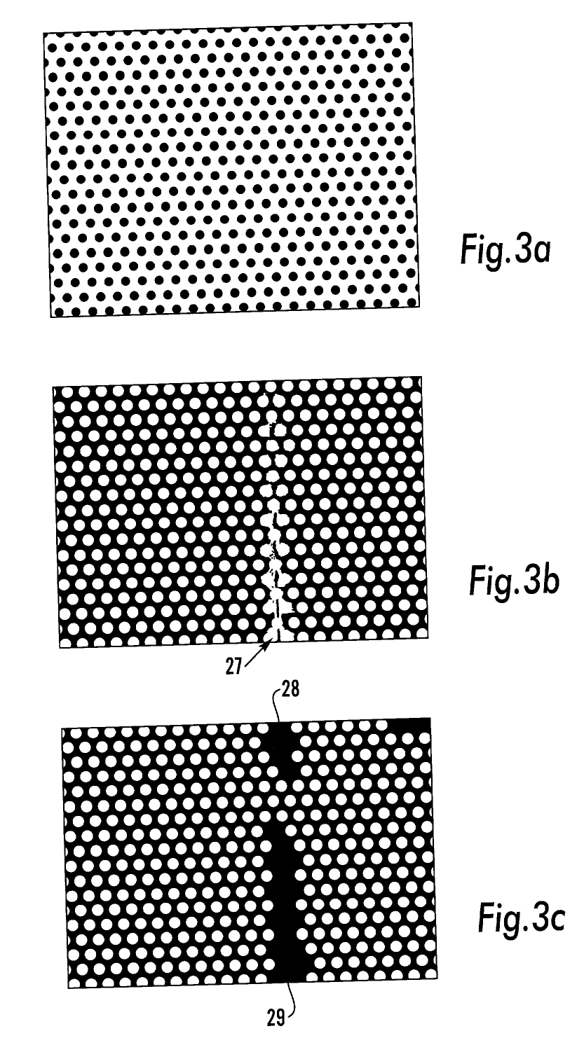

FIG. 3a shows a captured image of the web of FIG. 2 produced by a frame grabber;

FIG. 3b shows a negative binarised image of the captured image of FIG. 3a;

FIG. 3c shows the image of FIG. 3b in which merged dots have been removed from the image; and

FIG. 4 shows examples of blobs.

A web 14 is shown in FIG. 1 travelling continuously from left to right, as viewed. During its passage the upper surface of the web is inspected at an inspection station and inspected web is rolled into a roll 13. The inspection station consists of a linescan camera 10 positioned in-line with, and spaced from, the axis 12 of a travelling web 14. From this position, the camera 10 is able to scan all or substantially all of the width 16 of travelling web 14. If the web 14 is too wide for one linescan camera 10 to scan substantially the whole width of the web, two or more cameras (not shown) may be positioned adjacent each other as required.

The web 14 is illuminated from a light source 15 having a constant light output and positioned above the web at the area of inspection. In an alternative arrangement, not shown, the light source 15 is positioned below the web 14.

The camera 10 instantaneously views a strip or line 18 across the width 16 of the web, at a time triggered by an external encoder 20, synchronised to the speed of movement of the web. The camera produces a digital image of the line 18 of one pixel width, and so in terms of pixels the image is one dimensional. For example, if a 2048 pixel line scan camera views a web with a width of 1024 mm, each pixel resolves 0.5 mm. Therefore, each line 18 scanned has a width 19 of 0.5 mm and the encoder should be set to trigger the camera 10 for every 0.5 mm of movement of the web. A “frame grabber” 21 produces a digitised image or frame by compiling a number of successive images of lines scanned, which can then be processed using software techniques with a computer 22.

If the encoder 20 does not trigger the camera in the manner described, to correspond with the physical parameters of the web and camera, a distorted frame is produced which can have any height for a given width. In some applications, it may not be necessary to produce a geometrically perfect image.

The web 14 as illustrated in FIG. 2, (not to scale) is of breathable fabric. Discrete dots 24 of chemical coating have been applied to a base fabric 26 in a regular pattern. The nature of the regular pattern, including the shape of the dots determines the extent of breathability of the fabric. The shade of the dots 24 is darker than the shade of the base fabric 26, which provides a clearly visible contrast between the dots and base fabric. In other fabric, not shown, the dots are lighter than the shade of the base fabric, but the contrast between the dots and base fabric is still clearly visible.

The camera 10 is a monochrome grey-scale camera, which produces an image in eight bit grey-scale format. This format comprises 256 levels of shade from black to white, with the level 0 being black, and level 255 being white. A captured image produced by the frame grabber can be seen in FIG. 3a , from which it is almost impossible to visually identify anomalies in the discrete dots representing the coating.

The captured image is then changed into a binary format for ease and speed of processing. A threshold value in the eight bit grey-scale format is selected, for example 180. Those pixels having a value below the threshold value are at level 0 and appear black, whereas all pixels above the threshold value are at level 1 and appear white. When viewed on screen, this has the effect of highlighting the dots as discrete black areas on a background of white. Any dark streaks on the background of the captured image between the dots, now appear as black and join the dots together, but even so, these still appear as discrete black areas on a background of white. The discrete black areas will now be referred to as blobs.

A negative binarised image is shown in FIG. 3b , in which the blobs appear white and the background black. A streak or area of merged blobs can be seen at 27. In FIG. 3c the merged blobs 27 have been removed from the image, and two areas of over-coating 28,29 are clearly visually identifiable.

The blobs of each frame are now counted. Frames containing blobs formed by merged dots produce a lower count per frame, and frames in which blobs are missing, that is where dots of coating are missing, also produce a lower count per frame. It is necessary to perform the count at this stage in the method, but the results of the count are utilised later in the method, as discussed further below.

After counting, the blobs of each frame are filtered to remove perfect dots by applying a convolution mask over the entire frame. The convolution mask is a mathematical representation of an ideal dot pattern. Perfect dots are removed from the blobs, thereby leaving behind any blob irregularities, for example the excess of larger blobs produced by over-coating, or the voids in blobs produced by under-coating. Consequently, by counting the total number of remaining pixels left in each frame, a grading value is accorded to each frame. If the coating was perfect, the grading value would be 0. Examples of blobs can be seen in FIG. 4. Blob 30 is a binarised image of a perfect dot, blobs 32 and 34 are images of over-coated dots, and blob 36 is an image of a dot with a void 38 in the coating.

The final step in the method is the comparison of the blob count per frame and the grading value of each frame with respective pre-set values or limits, which can be adjusted by the system operator.

If the values are within the pre-set limits, the quality of the coating is acceptable. However, if the values fall outside the pre-set limits, the quality of the coating is not acceptable and the fabric must be rejected. The unacceptable part of the web 14 is marked with ink, which is sprayed onto the underside of the web by a spray gun 40, shown in FIG. 1. When the fabric is being cut for use, the marked fabric is cut out and rejected. Alternatively, it is common practise to produce a roll map of the web 14 as it produced and inspected. The web 14 is marked at an arbitrary point and the distance from such a point to any unacceptable fabric is recorded automatically. The roll map is then used later to identify fabric to be rejected.

1. An automatic inspection method for inspecting a web having a regular pattern of discrete areas thereon or therein, comprising the steps of scanning a portion of the web with a camera to produce a digital image of the scanned web portion, converting the digital image into binary format and counting the number of discrete areas portrayed in the binary format image, filtering the binary format image for identifying any deviation from an ideal binary format image, counting the number of pixels comprising the deviation from the ideal image to yield a grading value, and comparing the discrete area count and grading value of the image with respective pre-set limits for determining the quality of the pattern.

2. A method as claimed in claim 1, in which the step of filtering the binary format image is achieved by applying a convolution mask.

3. A method as claimed in claim 1 or 2, including the step of rejecting a portion of the inspected web should the grading value and discrete area count lie outside the pre-set limits thus indicating the quality of the pattern to be unacceptable.

4. A method as claimed in claim 1,2 or 3 in which the web being inspected is illuminated from a light source having a constant light output.

5. A method as claimed in claim 4 in which the light source is located above the web being inspected.

6. A method as claimed in any one of the claims 1 to 5 in which the web is travelling continuously in a given direction at a substantially constant speed corresponding to the speed of production of the web.

7. A method as claimed in any one of claims 1 to 5 in which the web travels in a stepwise manner being stationary during scanning.

8. A method as claimed in any one of claims 1 to 7 in which the camera is a digital linescan camera having a monochrome grey-scale.

9. A method as claimed in claim 8 in which an external encoder is provided which is synchronised to the speed of movement of the web and which triggers the camera to scan a line across the web.

10. A method as claimed in any one of claims 1 to 9 in which a frame grabber is provided which produces a digitised image or frame of the scanned web portion by compiling a number of successive images of lines scanned.

11. A method as claimed in any one of claims 1 to 10 in which the web is of paper, plastic, film,or netting.

12. A method as claimed in claim 11 in which the fabric is a breathable fabric comprising discrete dots of chemical coating which have been applied to a base fabric in a regular pattern.

13. A method as claimed in claim 12 in which the shade of the dots is lighter than the shade of the base fabric which provides a clearly visible contrast between the dots and base fabric.

14. A web having a regular pattern of discrete areas thereon or therein whenever having been inspected by the method as claimed in claim 1.

15. An automatic inspection method substantially as described herein with reference to and as illustrated in any one of the accompanying drawings.
